(19) United States
(12) Patent Application Publication
(10) Pub. No.: US 2005/0216564 A1
(43) Pub. Date: Sep. 29, 2005

(54) Method and apparatus for analysis of electronic communications containing imagery

(76) Inventors: Gregory K. Myers, San Francisco, CA (US); John P. Marcotullio, Morgan Hill, CA (US); Prasanna Mulgaonkar, Saratoga, CA (US); Hrishikesh B. Aradhye, Mountain View, CA (US)

Correspondence Address: MOSER, PATTERSON & SHERIDAN, LLP;SRI INTERNATIONAL, 595 SHREWSBURY AVENUE, SUITE 100, SHREWSBURY, NJ, 07702, US

(21) Appl. No.: 10/925,335

(22) Filed: Aug. 24, 2004

Related U.S. Application Data
(60) Provisional application No. 60/552,625, filed on Mar. 11, 2004.

(51) Int. Cl. G06F 15/16

(52) U.S. Cl. 709/206; 713/201

(57) ABSTRACT

A method and apparatus are provided for analyzing an electronic communication containing imagery, e.g., to determine whether or not the electronic communication is a spam communication. In one embodiment, an inventive method includes detecting one or more regions of imagery in a received electronic communication and applying pre-processing techniques to locate regions (e.g., blocks or lines) of text in the imagery that may be distorted. The method then analyzes the regions of text to determine whether the content of the text indicates that the electronic communication is spam. In one embodiment, specialized extraction and rectification of embedded text followed by optical character recognition processing is applied to the regions of text to extract their content therefrom. In another embodiment, keyword recognition or shape-matching processing is applied to detect the presence or absence of spam-indicative words from the regions of text. In another embodiment, other attributes of extracted text regions, such as size, location, color and complexity are used to build evidence for or against the presence of spam.

### CROSS REFERENCE TO RELATED APPLICATIONS

This application claims the benefit of U.S. Provisional Patent Application Ser. No. 60/552,625, filed Mar. 11, 2004 (titled “System and Method for Analysis of Electronic Mail Containing Imagery”), which is herein incorporated by reference in its entirety.

### FIELD OF THE INVENTION

The present invention relates generally to electronic communication networks and relates more specifically to the analysis of network communications to classify and filter electronic communications containing imagery.

### BACKGROUND OF THE DISCLOSURE

As the usage of electronic mail (e-mail) and cellular text message communication continues to increase, so too does the volume of unsolicited commercial communications (or “spam”) being sent to e-mail and text message users. The volume of spam has long been viewed as a threat to the utility of e-mail and text messaging as effective communication media, prompting many proposed solutions to combat the reception of spam. Among these solutions are systems that accept communications only from pre-approved senders or that search the text of incoming communications for keywords generally indicative of spam.

Unfortunately, the senders of spam are finding ways to circumvent such systems. For example, one way in which senders have attempted to thwart key-word based text search systems is to place text in imagery such as still images, video images, animations, applets, scripts and the like, so that its message remains perceptible to the viewer and at the same time is shielded from the text search. Traditional anti-spam techniques, which typically ignore imagery or perform limited comparisons based on a hash of still image data, are thus ineffective to combat this approach. Moreover, techniques used to hash images are only effective in the case where the images in the communication being examined are identical to any one of the images used to train the anti-spam classification system. Thus, minor modifications can be made to any imagery in a spam communication to defeat this approach. For these reasons, spam communications containing imagery account for roughly 25% of all spam sent, and this number is expected to increase unless a viable solution is found to counter such communications.

Thus, there is a need in the art for a method and apparatus for analysis of electronic communications containing imagery.

### SUMMARY OF THE INVENTION

A method and apparatus are provided for analyzing an electronic communication containing imagery, e.g., to determine whether or not the electronic communication is a spam communication. In one embodiment, an inventive method includes detecting one or more regions of imagery in a received electronic communication and applying pre-processing techniques to locate regions (e.g., blocks or lines) of text in the imagery that may be distorted. The method then analyzes the regions of text to determine whether the content of the text indicates that the electronic communication is spam. In one embodiment, specialized extraction and rectification of embedded text followed by optical character recognition processing is applied to the regions of text to extract their content therefrom. In another embodiment, keyword recognition or shape-matching processing is applied to detect the presence or absence of spam-indicative words from the regions of text. In another embodiment, other attributes of extracted text regions, such as size, location, color and complexity are used to build evidence for or against the presence of spam.

### BRIEF DESCRIPTION OF THE DRAWINGS

The teachings of the present invention can be readily understood by considering the following detailed description in conjunction with the accompanying drawings, in which:

FIG. 1 is a flow diagram illustrating one embodiment of a method for analyzing and classifying incoming electronic communications according to the present invention;

FIG. 2 is a flow diagram illustrating one embodiment of a method for classifying electronic communications by applying OCR to imagery contained therein to detect spam;

FIG. 3 is an illustration of an exemplary still image from an electronic communication;

FIG. 4 illustrates exemplary text extraction generated by applying OCR processing to the image illustrated in FIG. 3;

FIG. 5 is a flow diagram illustrating one embodiment of a method for analyzing and classifying electronic communications by applying keyword recognition processing to imagery contained therein to detect spam;

FIG. 6 is a flow diagram illustrating one embodiment of a method for analyzing and classifying electronic communications by detecting the presence or absence of spam-indicative attributes of imagery contained therein; and

FIG. 7 is a high level block diagram of the present method for analyzing electronic communications containing imagery that is implemented using a general purpose computing device.

To facilitate understanding, identical reference numerals have been used, where possible, to designate identical elements that are common to the figures.

### DETAILED DESCRIPTION

The present invention relates to a method and apparatus for analysis of electronic communications (e.g., e-mail and text messages) containing imagery or links to imagery (e.g., e-mail attachments or pointers to web pages). In one embodiment, specialized background separation and distortion rectification followed by optical character recognition (OCR) processing are applied to an electronic communication in order to analyze imagery contained in the communication, e.g., for the purposes of filtering or categorizing the communication. For example, the inventive method may be applied to detect the receipt of spam communications. As used herein, the term “spam” refers to any unsolicited electronic communications, including advertisements and communications designed for “phishing” (e.g., designed to elicit personal information by posing as a legitimate institution such as a bank or internet service provider), among others. In further embodiments, the inventive method may be applied to filter outgoing electronic communications, e.g., in order to ensure that proprietary information (such as images or screen shots of software source codes, product designs, etc.) is not disseminated to unauthorized parties or recipients.

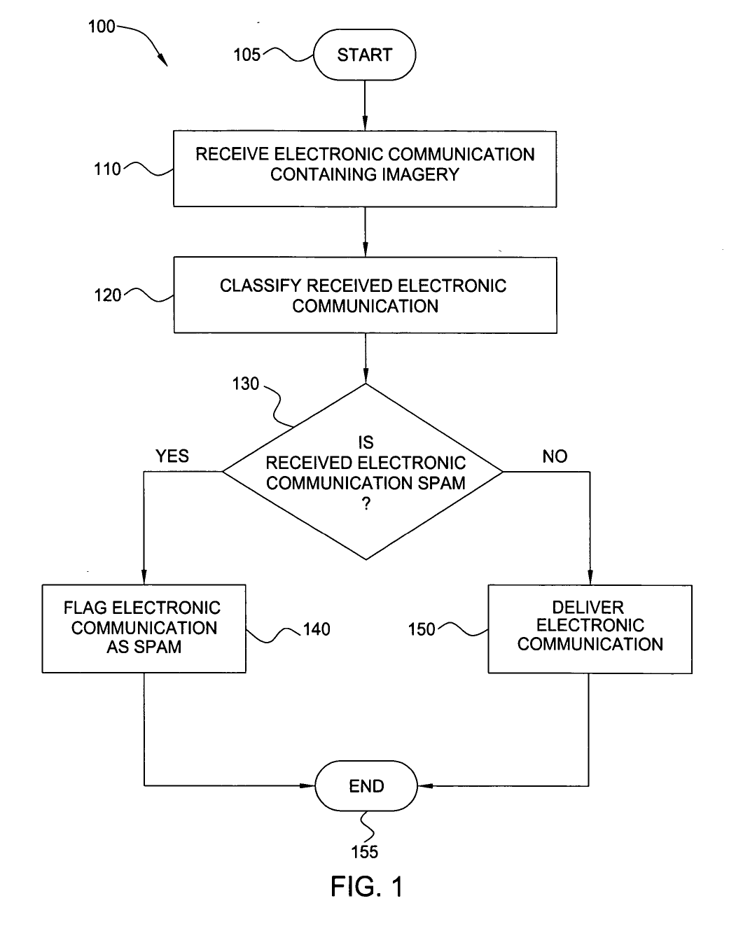

FIG. 1 is a flow diagram illustrating one embodiment of a method 100 for analyzing and classifying electronic communications according to the present invention. The method 100 is initialized at step 105 and proceeds to step 110, where the method 100 receives an electronic communication containing one or more embedded imagery elements. The received electronic communication may be an incoming communication (e.g., being received by a user) or an outgoing communication (e.g., being sent by a user).

In one embodiment (e.g., a mail user agent embodiment), the electronic communication is an e-mail communication, and the method 100 receives the e-mail communication by retrieving the communication from a server (e.g., a Post Office Protocol (POP) or Internet Message Access Protocol (IMAP) server) or from a file containing one or more e-mail communications. In another embodiment (e.g., a mail retrieval agent embodiment or IMAP server), the method 100 receives the e-mail communication by reading the e-mail communication from a file in preparation for delivery to a client mail user agent. In yet another embodiment (e.g., a mail transport agent embodiment, Simple Mail Transport Protocol (SMTP) server or proxy server), the method 100 receives the e-mail communication over a network from a second mail transport agent (e.g., including a mail user agent or proxy agent acting in the capacity of a mail transport agent), or from a file containing a cached copy of an e-mail communication previously received over a network from a second mail transport agent.

In step 120, the method 100 classifies the electronic communication as spam (e.g., as containing unsolicited or unauthorized information) or as a legitimate (e.g., non-spam) communication. As described in further detail below, in one embodiment step 120 involves analyzing one or more imagery elements in the received electronic communication. If more than one imagery element is present, in one embodiment, the imagery elements are classified in parallel. In another embodiment, the imagery elements are classified sequentially. In one embodiment, the method 100 performs step 120 in accordance with one or more of the methods described further herein.

In step 130, the method 100 determines if the electronic communication has been classified as spam. If the electronic communication has not been classified as spam in step 120, the method 100 proceeds to step 150 and delivers the electronic communication, e.g., in the normal manner, to the intended recipient. In one embodiment, the electronic communication is an e-mail communication, and the e-mail is delivered to the intended recipient via server-based routing protocols. In another embodiment, the electronic communication is a text message, e.g., a server-mediated direct phone-to-phone communication. The method 100 then terminates in step 155.

Alternatively, if the method 100 concludes in step 130 that the electronic communication has been classified as spam, the method 100 proceeds to step 140 and flags the electronic communication as such. In one embodiment (e.g., a mail user agent embodiment), the method 100 flags the communication by automatically deleting the communication before it can be delivered to the intended recipient. In another embodiment, the method 100 flags the communication by labeling the message on a user display or by filing the communication in a folder designated for spam prior to delivering the communication to the intended recipient. In another embodiment (e.g., a mail retrieval agent embodiment or a proxy server embodiment), the method 100 flags the communication by inserting a custom e-mail header (e.g., “X-is-Spam: Yes”) prior to delivering the communication to the intended recipient. In yet another embodiment (e.g., a mail transfer agent embodiment), the method 100 flags the communication by creating a “bounce” message that informs the sender of a delivery failure. The method 100 then terminates in step 155.

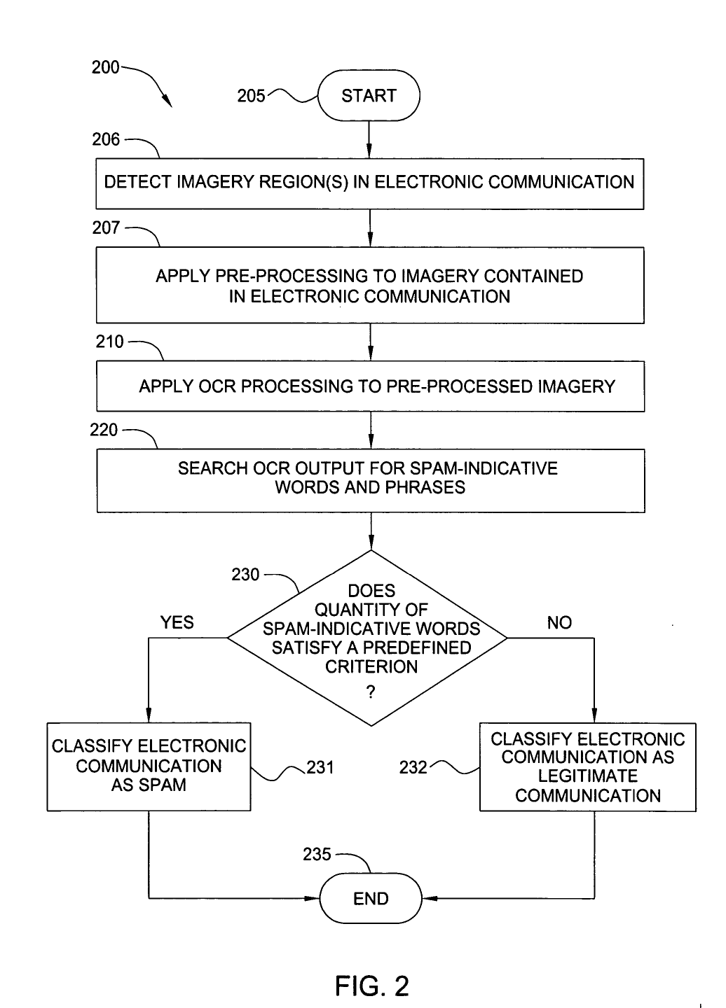

FIG. 2 is a flow diagram illustrating one embodiment of a method 200 for classifying electronic communications in accordance with step 120 of the method 100, e.g., by applying OCR to imagery contained therein to detect unsolicited or unauthorized communications. The method 200 is initialized at step 205 and proceeds to step 206, where the method 200 detects an imagery region in a received electronic communication. As discussed above, the imagery regions may contain still images, video images, animations, applets, scripts and the like.

In step 207, the method 200 applies pre-processing techniques to one or more detected imagery regions contained in the communication in order to isolate instances of text from the underlying imagery. In one embodiment, the applied pre-processing techniques include a text block location technique that detects the presence of collinear pieces and/or other text-specific characteristics (e.g., neighboring vertical edges, bimodal intensity distribution, etc.), and then links the pieces or characteristic elements together to form a text block. The text block location technique enables the method 200 to identify lines of text that may have been distorted. Text distortions may include, for example, text that has been superimposed over complex (e.g., non-uniform) backgrounds such as photos and advertisement graphics, text that is rotated, or text that is skewed (e.g., so as to appear not to be perpendicular to an axis of viewing) in order to enhance visual appeal and/or evade detection by conventional text-based spam detection or filtering techniques.

In one embodiment, a pre-processing technique that is developed specifically for the analysis of imagery (e.g., as opposed to pre-processing techniques for conventional plain text) is implemented in step 207. Pre-processing techniques that may be implemented to particular advantage in step 207 include those techniques described in co-pending, commonly assigned U.S. patent application Ser. No. 09/895,868, filed Jun. 29, 2001, which is herein incorporated by reference.

In step 210, the method 200 applies OCR processing to the pre-processed imagery. The OCR output will be a data structure containing recognized characters and/or words, in one embodiment arranged in the phrases or sentences in which they were arranged in the imagery.

In step 220, the method 200 searches the OCR output generated in step 210 for the occurrence of trigger words and/or phrases that are indicative of spam, or that indicate proprietary or unauthorized information. In one embodiment of step 220, the method 200 compares the OCR output against a list of known (e.g., predefined) spam-indicative words (or words that indicate proprietary information) in order to determine if any of the output substantially matches one or more words on the list. In a further embodiment, such a comparison is performed using a traditional text-based spam identification tool, e.g., so that the OCR output is interpreted as if it were an electronic communication containing solely text. Such an approach advantageously enables the method 200 to leverage advances in text-based spam identification techniques, such as partial word matches, word matches with common misspellings, deliberate swapping of similar letters and numerals (e.g., the upper-case letter O and the numeral 0, upper-case Z and the numeral 2, lower-case I and the numeral 1, etc.), and insertion of extra characters (including spaces) into the text, among others.

In one embodiment, the method 200 may tag words and phrases identified as spam-indicative (or indicative of unauthorized information) with a likelihood metric or confidence score (e.g., associated with a degree of likelihood that the presence of the tagged word or phrase indicates that the electronic communication is in fact spam or does in fact contain unauthorized information). For example, if the method 200 has extracted and identified the phrase “this is not spam” in the analyzed imagery, the method 200 may, at step 220, tag the phrase with a relatively high confidence score since the phrase is likely to indicate spam. Alternatively, the phrase “business opportunity” may be tagged with a lower score relative to “this is not spam”, because the phrase sometimes indicates spam and sometimes indicates a legitimate communication. Thus, in step 220, the method 200 may generate a list of the possible spam-indicative words and their respective confidence scores.

At step 230, the method 200 determines whether a quantity of spam-indicative words (or words indicating unauthorized information) detected in the analyzed region(s) of imagery satisfies a pre-defined filtering criterion (e.g., for identifying spam communications). In one embodiment, imagery is classified as spam if the number of spam-indicative words and/or phrases contained therein exceeds a predefined threshold. In one embodiment, this pre-defined threshold is user-definable in order to allow users to tune the sensitivity of the method 200, for example to decrease the incidence of false positives, or legitimate communications classified as spam (e.g., by increasing the threshold), or to decrease the incidence of false-negatives, or spam communications classified as non-spam (e.g., by decreasing the threshold).

In another embodiment, e.g., where step 220 generates confidence scores for potential spam-indicative words, the method 200 aggregates the respective confidence scores in step 230 to form a combined confidence score. If the combined confidence score exceeds a pre-defined (e.g., user-defined) threshold, the associated imagery is classified as spam. In one embodiment, the combined confidence score is simply the sum of all confidence scores for all possible spam-indicative words located in the imagery. Those skilled in the art will appreciate that other methods of aggregating the confidence scores (e.g., calculating a mean or median score, among others) may also be implemented in step 230 without departing from the scope of the invention.

Thus, if the pre-defined criterion is determined to be satisfied in step 230, the method 200 proceeds to step 231 and classifies the received electronic communication as spam, or as an unauthorized communication (e.g., in accordance with step 120 of FIG. 1). Alternatively, if the method 200 determines that the predefined criterion has not been satisfied, the method 200 proceeds to step 232 and classifies the electronic communication as a legitimate communication. In step 235, the method 200 terminates.

In some cases where an electronic communication contains more than one imagery element, it is possible that some imagery elements may be classified as spam-indicative and some imagery elements may be classified as legitimate or questionable. In some embodiments of the present invention, the method 200 (or any of the methods described further herein) will classify electronic communication as spam if the communication contains at least one imagery element that is classified as spam. In other embodiments, the method 200 (or any of the methods described further herein) will classify an electronic communication as spam according to a threshold approach (e.g., more than 50% of the contained imagery elements are classified as spam). In further embodiments, a tagged threshold approach is used, where an entire imagery element is tagged with a collective score that is the aggregation of all scores for spam-indicative words contained in the imagery. The collective scores for a predefined number of the imagery elements must all be greater than a predefined threshold value.

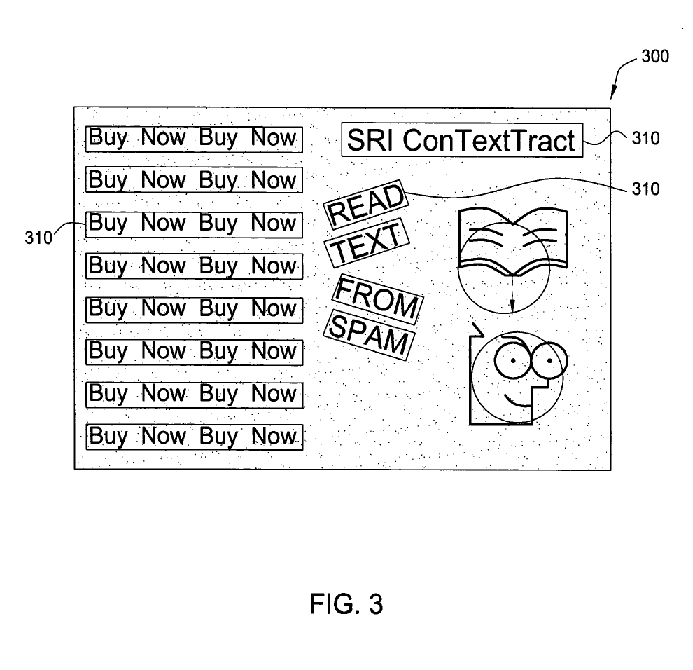

FIG. 3 illustrates an exemplary still image 300 from an electronic communication. The image 300 comprises several imagery regions containing text components 310 that can be analyzed and classified, e.g., according to the methods 100 and 200. As illustrated in FIG. 3, several text components 310 have been identified, isolated from the background, and rectified to remove the effects of rotation and other distortions (as indicated by the boxed outlines) for further processing, e.g., in accordance with step 207 of the method 200.

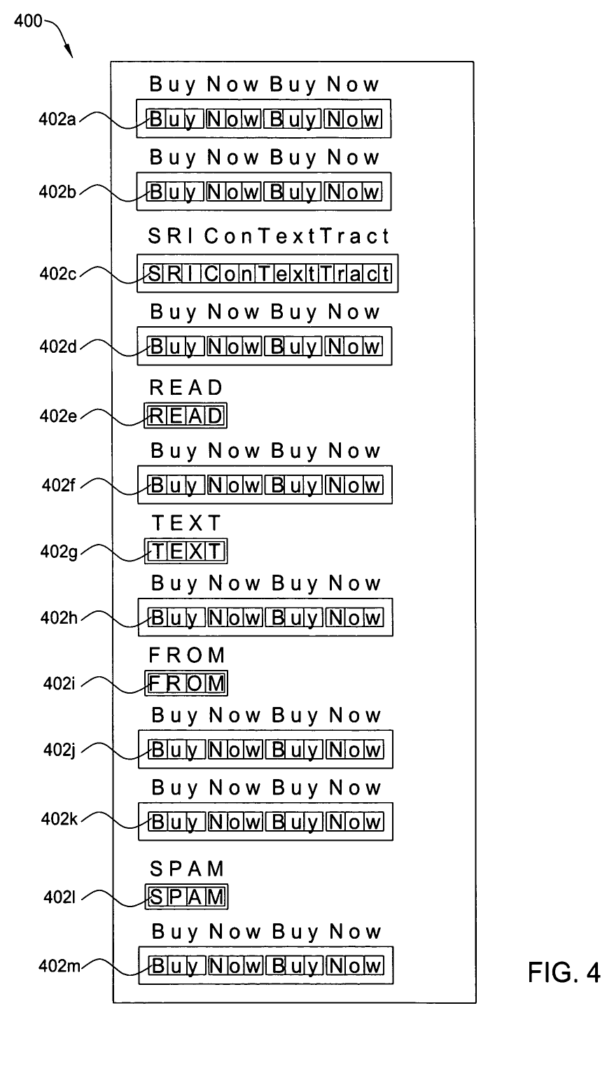

FIG. 4 illustrates exemplary text extraction generated by applying OCR processing to the image 300, e.g., in accordance with step 210 of FIG. 2. A plurality of identified phrases, strings and partial stings 402a-402m is shown (e.g., arranged from top to bottom according to their appearance in the image 300). Several strings, e.g., “Buy Now Buy Now” (402a) and “SRI ConTextTract” (402b) have achieved perfect recognition. Matching any extraction results that have achieved a lesser degree recognition to a vocabulary of words stored in a lexicon may aid in further extracting additional words and phrases. The resultant strings 402a-402m are then classified, e.g., in accordance with steps 220-230 of the method 200 or in accordance with alternative methods disclosed herein, enabling the identification of the communication containing the image 300 as either probable spam or a probable legitimate communication.

In some cases, a spam communication may contain text words that are intentionally split among multiple adjacent imagery elements in order to avoid detection in an imagery element-by-imagery element analysis. Thus, in one embodiment, step 220 searches for prefixes or suffixes or known spam-indicative words. In other embodiment, the method 200 may further comprise a step of re-assembling the individual imagery elements into a single composite image, e.g., in accordance with known image reassembly techniques such as those used in some web browsers, prior to applying OCR processing.

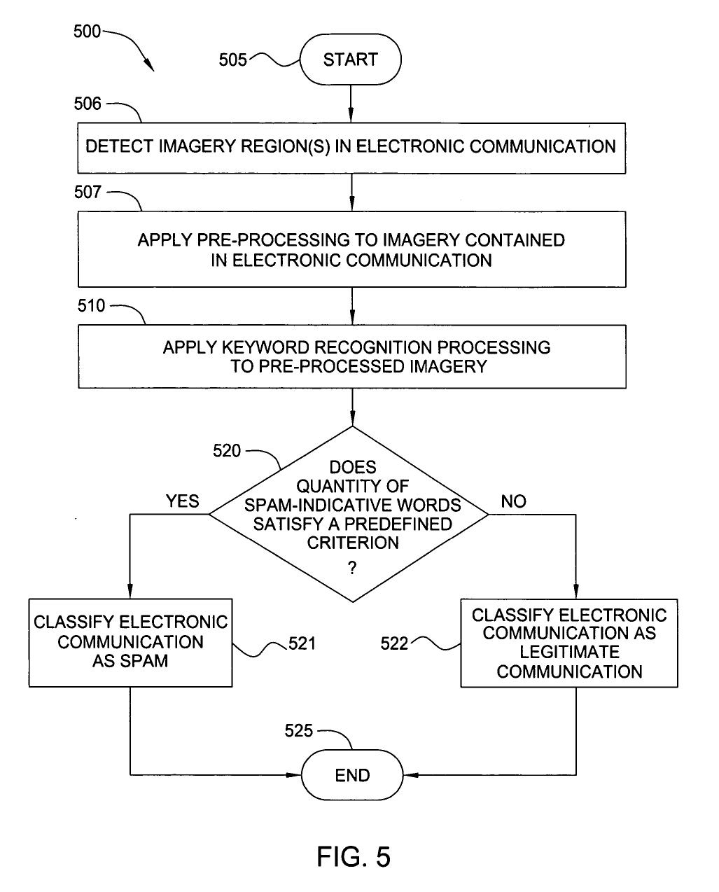

FIG. 5 is a flow diagram illustrating another embodiment of a method 500 for analyzing and classifying electronic communications in accordance with step 120 of the method 100, e.g., by applying keyword recognition processing to imagery contained therein to detect unsolicited or unauthorized communications. The method 500 is similar to the method 200, but uses keyword recognition, rather than character recognition techniques, to extract information out of imagery. The method 500 is initialized at step 505 and proceeds to step 506, where the method 500 detects one or more regions of imagery within a received electronic communication.

The method 500 then proceeds to step 507, where the method 500 applies pre-processing techniques to the imagery detected in the electronic communication in order to isolate and rectify instances of text from the underlying imagery. In one embodiment, an applied pre-processing technique is similar to the text block location approach applied within an imagery region and described with reference to the method 200.

In step 510, the method 500 applies keyword recognition processing to the pre-processed imagery. In one embodiment, the keyword recognition processing technique used differs from conventional OCR techniques by focusing on the recognition of entire words, rather than the recognition of individual text characters, that are contained in an analyzed imagery. That is, the keyword recognition process does not reconstruct a word by first separating and recognizing individual characters within the word. In another embodiment, each keyword is represented by the Hidden Markov Model (HMM) of image pixel values or features, and dynamic programming is used to match the features found in the pre-processing text region with the model of each keyword.

In one embodiment, the keyword recognition processing technique focuses on the shapes of words contained in the imagery and is substantially similar to the techniques described by J. DeCurtins, “Keyword Spotting Via Word Shape Recognition”, SPIE Symposium on Electronic Imaging, San Jose, Calif., February 1995 and J. L. DeCurtins, “Comparison of OCR Versus Word Shape Recognition for Keyword Spotting”, Proceedings of the 1997 Symposium on Document Image Understanding Technology, Annapolis, Md., both of which are hereby incorporated by reference. These techniques are based on the knowledge that machine-printed text words can be identified by their shapes and features, such as the presence of ascenders (e.g., text characters having components that ascend above the height of lowercase characters) and descenders (e.g., the characters having components that descend below a baseline of a line of text). Generally, these techniques segment words out of imagery and match the segmented words to words in a library by comparing corresponding shaped features of the words.

Thus, in step 510, the method 500 compares the words that are segmented out of the imagery against a list of known (e.g., predefined) trigger words (e.g., spam-indicative words or words that indicate unauthorized information) and identifies those segmented words that substantially or closely match some or all of the words on the list. In one embodiment, such a comparison is performed using a traditional text-based spam identification tool, e.g., similar to step 220 of the method 210.

The method then proceeds to step 520 and determines whether a quantity of spam-indicative words detected in the analyzed region(s) of imagery (e.g., in step 510) satisfies a pre-defined criterion for identifying spam communications. In one embodiment, a threshold approach, as described above with reference to step 230 of the method 200, is implemented in step 520 to determine whether results obtained in step 510 indicate that the analyzed communication is spam. In another embodiment, a confidence metric tagging approach, as also described above with reference to step 230 of the method 200 is implemented.

If the method 500 determines in step 520 that a quantity of detected spam-indicative words does satisfy the pre-defined criterion, the method 500 proceeds to step 521 and classifies the received electronic communication as spam, or as an unauthorized communication (e.g., in accordance with step 120 of the method 100). Alternatively, if the method 500 determines that the pre-defined criterion has not been satisfied, the method 500 proceeds to step 522 and classifies the received electronic communication as a legitimate communication. One the received electronic communication has been classified, the method 500 then terminates at step 525.

In one embodiment, the method 500 may employ a key-logo spotting technique, e.g., wherein, at step 510, the method 500 searches for symbols or characters other than text words. For example, the method 500 may search for corporate logos or for symbols commonly found in spam communications. In one embodiment, where such a technique is employed, the pre-processing step 506 also includes logo rectification and/or distortion tolerance processing in order to locate symbols or logos that have been intentionally distorted or skewed.

In one embodiment, the method 500 is especially well-suited for the detection of words that have been intentionally misspelled, e.g., by substituting numerals or other symbols for text letters (e.g., V1AGRA instead of VIAGRA). This is because rather than identifying individual text characters and then reconstructing words from the identified text characters, the method 500 focuses instead on the overall shapes of words. Thus, while a word spelled “V1AGRA” would evade detection by conventional (e.g., word reconstruction) methods (because letter-for-letter, it does not match a known English word or a known brand name), it would not evade detection by a shape-matching technique such as that used in the method 500 (because the shape of the word “V1AGRA” is substantially similar to the shape of the known word “VIAGRA”—this visual similarity is, in fact, why humans would easily perceive the word correctly in spite of the incorrect spelling).

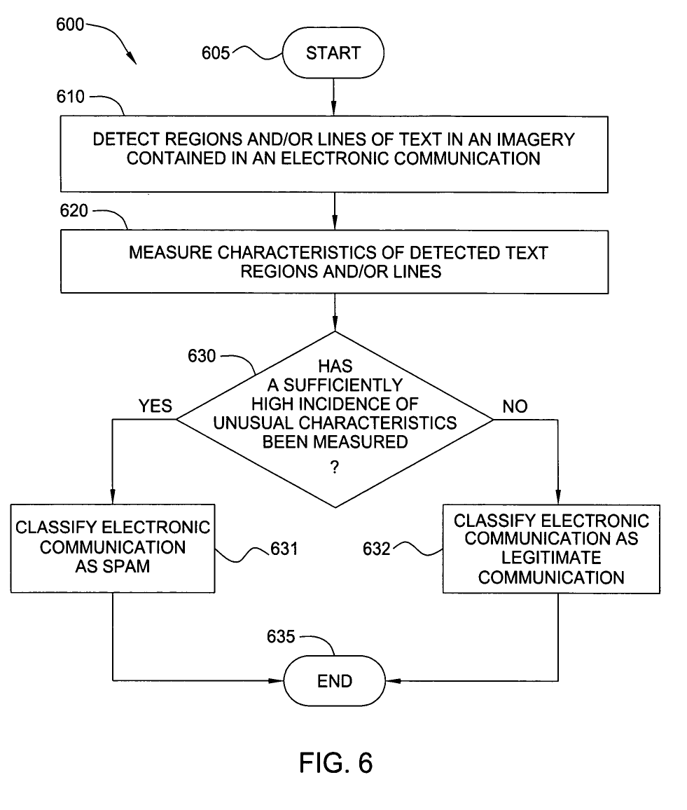

FIG. 6 is a flow diagram illustrating one embodiment of a method 600 for analyzing and classifying electronic communications in accordance with step 120 of the method 100, e.g., by analyzing attributes of imagery contained therein to detect unsolicited or unauthorized communications. The method 600 is initialized at step 605 and proceeds to step 610, where the method 600 detects regions (e.g., blocks or lines) of text in an imagery being analyzed, e.g., in accordance with pre-processing techniques described earlier herein or known in OCR and keyword recognition processing.

In step 620, the method 600 measures characteristics of the detected regions of text. In one embodiment, the characteristics to be measured include attributes that are common in spam communications but not common in non-spam communications, or vice versa. For example, imagery in spam communications frequently includes advertisement or other text superimposed over a photo or illustration, whereas most non-spam communication does not typically present text superimposed over images. In other examples, proprietary product designs may include text or characters superimposed over schematics, charts or other images.

In one embodiment, step 620 includes identifying any unusual (e.g., potentially spam-indicative) characteristics of the detected text region or line, apart from its textual content. In one embodiment, such measurement and identification is performed by considering such a set of image pixels within the detected text region or line that is not part of the characters of the text. For example, if the distribution of colors or intensities of the set of image pixels varies greatly, or if the distribution is similar to that of the non-text regions of the analyzed imagery, then the characteristics may be determined to be highly unusual, or likely indicative of spam content. In one embodiment, other measured characteristics may include the number, colors, positions, intensity distributions and sizes of text lines or regions and characters as evidence of the presence or absence of spam. For example, photos captured by an individual often contain no text whatsoever, or may have small characters, such as a date, superimposed over a small portion of the image. On the other hand, spam-indicative imagery typically displays characters that are larger in size, more in number, colorful, and much more prominently placed in the imagery in order to attract attention.

As another example, spam imagery may contain cursive form text, which is not common in typical legitimate electronic communications. In one embodiment, step 620 detects and distinguishes cursive text from non-cursive machine printed fonts by computing the connected components in the detected text regions and analyzing the height, width and pixel density of the regions (e.g., in accordance with known connected component analysis techniques). In general, cursive text will tend to have fewer, larger and less dense connected components.

In yet another example, some spam imagery may contain text that has been deliberately distorted in an attempt to prevent recognition by conventional OCR and filtering techniques. These distortions may comprise superimposing the text over complex backgrounds/imagery, inserting random noise or distorting or interfering patterns, distorting the sizes, shapes, colors, intensity distributions and orientations of the text characters or overlapping the text characters on background image patterns that do not commonly appear in legitimate electronic communications. Thus, in one embodiment, step 620 may further include the detection of such distortions. For example, one type of distortion places text on a grid background. In one embodiment, the method 600 detects the underlying grid pattern by detecting lines in and around the text region. In another embodiment, the method 600 detects random noise by finding a large number of connected components that are much smaller than the size of the text. In yet another embodiment, the method 600 detects distortions of character shapes and orientations by finding a smaller than usual (e.g., smaller than is average in normal text) proportion of straight edges and vertical edges along the borders of the text characters and by finding a high proportion of kerned characters. In yet another embodiment, the method 600 detects overlapping text by finding a low number of connected components, each of which is more complex than a single character.

At step 630, the method 600 determines whether the measurement of the characteristics of the detected text regions and lines performed in step 620 has indicated a sufficiently high extent embodiment, the analyzed imagery is assigned a confidence score that reflects the extent of unusual characteristics contained therein. If the confidence score exceeds a predefined threshold, the communication containing the analyzed imagery is classified as spam. In one embodiment, other scoring systems, including decisions trees and neural networks, among others, may be implemented in step 630. Once the communication has been classified, the method 600 terminates at step 635.

In one embodiment, a combination of two or more of the methods 200, 500 and 600 may be implemented in accordance with step 120 of the method 100 to detect unsolicited or unauthorized electronic communications. In one embodiment, the one or more methods are implemented in parallel. In another embodiment, the one or more methods 200, 500 and 600 are implemented sequentially. In further embodiments, other techniques for identifying spam may be implemented in combination with one or more of the methods 200, 500 and 600 in a unified framework. For example, in one embodiment, the method 200 is implemented in combination with the method 500 by combining spam-indicative words identified in step 220 (of the method 200) with the spam-indicative words identified in step 510 (of the method 500) for spam classification purposes. In one embodiment, spam-indicative words identified by both methods,200 and 500 count only once for spam classification purposes.

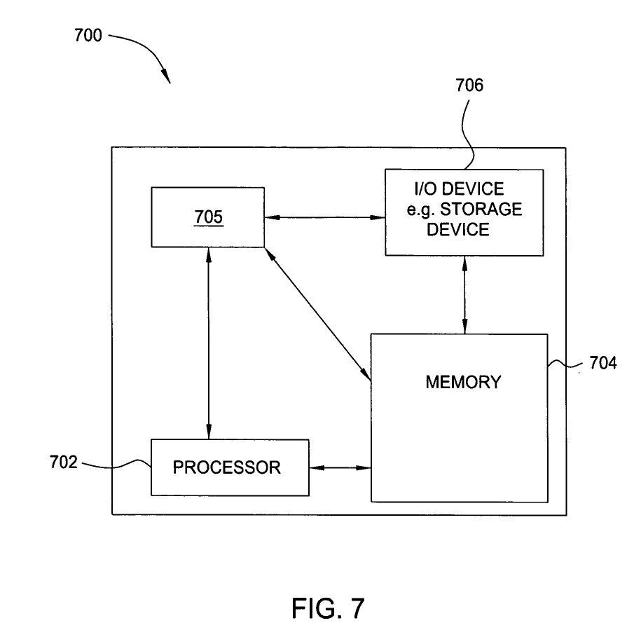

FIG. 7 is a high level block diagram of the present method for analyzing electronic communications containing imagery that is implemented using a general purpose computing device 700. In one embodiment, a general purpose computing device 700 comprises a processor 702, a memory 704, an imagery analysis module 705 and various input/output (I/O) devices 706 such as a display, a keyboard, a mouse, a modem, and the like. In one embodiment, at least one I/O device is a storage device (e.g., a disk drive, an optical disk drive, a floppy disk drive). It should be understood that the imagery analysis module 705 can be implemented as a physical device or subsystem that is coupled to a processor through a communication channel.

Alternatively, the imagery analysis module 705 can be represented by one or more software applications (or even a combination of software and hardware, e.g., using Application Specific Integrated Circuits (ASIC)), where the software is loaded from a storage medium (e.g., I/O devices 706) and operated by the processor 702 in the memory 704 of the general purpose computing device 700. Thus, in one embodiment, the imagery analysis module 705 for analyzing electronic communications containing imagery described herein with reference to the preceding Figures can be stored on a computer readable medium or carrier (e.g., RAM, magnetic or optical drive or diskette, and the like).

Those skilled in the art will appreciate that the methods of the present invention may be implemented in applications other than the electronic communication filtering applications described herein. For example, the methods described herein could be implemented in a system for identifying and filtering unwanted advertisements in a video stream (e.g., so that the video stream, rather than discrete messages, is processed). Alternatively, the methods described herein may be adapted to determine a likely source or subject of a communication (e.g., the communication is likely to belong to one or more specified categories), in addition to or instead of determining whether or not the communication is unsolicited or unauthorized. For example, one or more methods may be adapted to categorize electronic communications (e.g., stored on a hard drive) for forensic purposes, such that the communications may be identified as likely being sent by a criminal, terrorist or other organization.

Thus, the present invention represents a significant advancement in the field of electronic communication classification and filtering. In one embodiment, the inventive method and apparatus are enabled to analyze electronic communications in which spam-indicative text or other proprietary or unauthorized textual information is contained in imagery such as still images, video images, animations, applets, scripts and the like. Thus, even though electronic communications may contain cleverly disguised or hidden text messages, the likelihood that the communications will be identified as legitimate communications is substantially reduced. E-mail and text messaging users are therefore less likely to have to sift through unwanted and unsolicited communications in order to identify important or expected messages, or to send proprietary information to unauthorized parties.

Although various embodiments which incorporate the teachings of the present invention have been shown and described in detail herein, those skilled in the art can readily devise many other varied embodiments that still incorporate these teachings.

1. A method for categorizing an electronic communication containing imagery, the method comprising the steps of:
locating portions of said imagery having text regions therein; and
analyzing said text regions to determine whether content of said text regions indicates that said electronic communication is likely to be unsolicited or unauthorized.

2. The method of claim 1, wherein said locating step comprises:
locating text regions that are distorted.

3. The method of claim 2, wherein distorted text regions comprise text regions that are superimposed over complex backgrounds, that include skewed text, or both.

4. The method of claim 1, wherein said analyzing step comprises:
identifying one or more words contained in said text regions; and
determining whether one or more of the identified words is a trigger word that indicates unsolicited and/or unauthorized information.

5. The method of claim 4, wherein said determining step comprises:
designating an identified word as a trigger word if said identified word substantially matches one or more words in a pre-defined library of trigger words.

6. The method of claim 5, wherein said designating step comprises:
applying a text-based spam identification tool to compare said identified word to words in said pre-defined library.

7. The method of claim 4, further comprising the step of:
designating said electronic communication as unsolicited and/or unauthorized if an occurrence of trigger words contained in said imagery satisfies a pre-defined criterion.

8. The method of claim 7, wherein said pre-defined criterion is a user-definable threshold defining a maximum acceptable quantity of trigger words for said imagery.

9. The method of claim 7, wherein said designating step comprises:
assigning a score to one or more identified words or phrases in said imagery, wherein said score indicates a likelihood that said identified words or phrases indicate that said electronic communication is unsolicited or unauthorized; and
concluding that said electronic communication is unsolicited and/or unauthorized if an aggregate score for said electronic communication exceeds a maximum acceptable score.

10. The method of claim 9, wherein said aggregate score is the sum of one or more scores for corresponding identified trigger words contained in one or more imagery elements in said electronic communication.

11. The method of claim 4, wherein said identifying step comprises:
applying optical character recognition (OCR) processing to said text regions to identify one or more words contained therein.

12. The method of claim 4, wherein said identifying step comprises:
applying keyword recognition processing to said text regions to identify one or more words contained therein.

13. The method of claim 12, wherein said keyword recognition processing comprises:
comparing the shape of at least a portion of a text region to the shapes of one or more keywords in a pre-defined keyword library; and
identifying said at least a portion of a text region as a trigger word if the shape of said at least a portion of a text region substantially matches the shape of one or more words contained in said keyword library.

14. The method of claim 12, wherein said keyword recognition processing comprises:
matching one or more features located in a text region to a hidden Markov model representing a keyword contained in a pre-defined keyword library; and
identifying said features as belonging to a trigger word.

15. A computer readable medium containing an executable program for categorizing an electronic communication containing imagery, where the program performs the steps of:
locating portions of said imagery having text regions therein; and
analyzing said text regions to determine whether content of said text regions indicates that said electronic communication is likely to be unsolicited or unauthorized.

16. The computer readable medium of claim 15, wherein said locating step comprises:
locating text regions that are distorted.

17. The computer readable medium of claim 16, wherein distorted text regions comprise text regions that are superimposed over complex backgrounds, that include skewed text, or both.

18. The computer readable medium of claim 15, wherein said analyzing step comprises:
identifying one or more words contained in said text regions; and
determining whether one or more of the identified words is a trigger word that indicates unsolicited and/or unauthorized information.

19. The computer readable medium of claim 18, wherein said determining step comprises:
designating an identified word as a trigger word if said identified word substantially matches one or more words in a pre-defined library of trigger words.

20. The computer readable medium of claim 19, wherein said designating step comprises:
applying a text-based spam identification tool to compare said identified word to words in said pre-defined library.

21. The computer readable medium of claim 18, further comprising the step of:
designating said electronic communication as unsolicited and/or unauthorized if an occurrence of identified trigger words contained in said imagery satisfies a pre-defined criterion.

22. The computer readable medium of claim 21, wherein said pre-defined criterion is a user-definable threshold defining a maximum acceptable quantity of trigger words for said imagery.

23. The computer readable medium of claim 21, wherein said designating step comprises:
assigning a score to one or more identified words or phrases in said imagery, wherein said score indicates the likelihood that said identified words or phrases indicate that said electronic communication is unsolicited or unauthorized; and
concluding that said electronic communication is unsolicited and/or unauthorized if an aggregate score for said electronic communication exceeds a maximum acceptable score.

24. The computer readable medium of claim 21, wherein said aggregate score is the sum of one or more scores for corresponding identified trigger words contained in one or more imagery elements in said electronic communication.

25. The computer readable medium of claim 18, wherein said identifying step comprises:
applying optical character recognition (OCR) processing to said text regions to identify one or more words contained therein.

26. The computer readable medium of claim 18, wherein said identifying step comprises:
applying keyword recognition processing to said text regions to identify one or more words contained therein.

27. The computer readable medium of claim 26, wherein said keyword recognition processing comprises:
comparing the shape of at least a portion of a text region to the shapes of one or more keywords in a pre-defined keyword library; and
identifying said at least a portion of a text region as a trigger word if the shape of said at least a portion of a text region substantially matches the shape of one or more words contained in said keyword library.

28. The computer readable medium of claim 15, wherein said keyword recognition processing comprises:
matching one or more features located in a text region to a hidden Markov model representing a keyword contained in a pre-defined keyword library; and
identifying said features as belonging to a trigger word.

29. Apparatus for categorizing an electronic communication containing imagery, the apparatus comprising:
means for locating portions of said imagery having text regions therein; and
means for analyzing said text regions to determine whether content of said text regions indicates that said electronic communication is unsolicited and/or unauthorized.

30. A method for categorizing an electronic communication containing imagery, the method comprising the steps of:
applying pre-processing techniques to said imagery in order to locate regions of text in said imagery;
measuring one or more characteristics of sets of image pixels within said regions of text; and
determining if one or more measured characteristics indicates that said electronic communication is likely to be unsolicited or unauthorized.

31. The method of claim 30, wherein said characteristics to be measured are one or more of the following: text superimposition over said imagery, distribution of colors in said imagery, distribution of intensity in said imagery, a number of text regions, positions of text regions, sizes of text regions, fonts used in text regions, the presence of random noise or distorting or interfering patterns, text overlap, text distortion and the presence of cursive text.

32. The method of claim 30, wherein said one or more measured characteristics indicate that said electronic communication is likely to be unsolicited or unauthorized if attributes of said characteristics are common in unsolicited or unauthorized communications but not common in legitimate electronic communications.

33. The method of claim 32, further comprising the step of:
concluding that said electronic communication is unsolicited or unauthorized if the incidence of characteristics indicating that said electronic communication is likely to be unsolicited or unauthorized satisfies a pre-defined criterion.

34. The method of claim 33, wherein characteristics indicating that said electronic communication is likely to be unsolicited or unauthorized are assigned a score associated with a degree of likelihood that the presence of said characteristics indicates that said electronic communication is in fact unsolicited or unauthorized.

35. The method of claim 34, wherein said pre-defined criterion is a maximum acceptable score representing an aggregate of scores of said characteristics.

36. The method of claim 30, wherein said pre-processing techniques comprise:
locating regions of text in said imagery that are superimposed over complex backgrounds, that are distorted, or both.

37. A computer readable medium containing an executable program for categorizing an electronic communication containing imagery, where the program performs the steps of:
applying pre-processing techniques to said imagery in order to locate regions of text in said imagery;
measuring one or more characteristics of sets of image pixels within said regions of text; and
determining if one or more measured characteristics indicates that said electronic communication is likely to be unsolicited or unauthorized.

38. The computer readable medium of claim 37, wherein said characteristics to be measured are one or more of the following: text superimposition over said imagery, distribution of colors in said imagery, distribution of intensity in said imagery, positions of text regions, sizes of text regions, fonts used in text regions, the presence of random noise, text overlap text, text distortion and the presence of cursive text.

39. The computer readable medium of claim 37, wherein said one or more measured characteristics indicate that said electronic communication is determining if one or more measured characteristics indicates that said electronic communication is likely to be unsolicited or unauthorized if attributes of said characteristics are common in unsolicited or unauthorized communications but not common in legitimate electronic communications.

40. The computer readable medium of claim 39, further comprising the step of:
concluding that said electronic communication is unsolicited or unauthorized if the incidence of characteristics indicating that said electronic communication is determining if one or more measured characteristics indicates that said electronic communication is likely to be unsolicited or unauthorized satisfies a pre-defined criterion.

41. The computer readable medium of claim 40, wherein characteristics indicating that said electronic communication is determining if one or more measured characteristics indicates that said electronic communication is likely to be unsolicited or unauthorized are assigned a score associated with a degree of likelihood that said characteristics indicate that said electronic communication is in fact unsolicited or unauthorized.

42. The computer readable medium of claim 41, wherein said pre-defined criterion is a maximum acceptable score representing an aggregate of scores of said characteristics.

43. The computer readable medium of claim 37, wherein said pre-processing techniques comprise:
locating regions of text in said imagery that are superimposed over complex backgrounds, that are distorted, or both.

44. Apparatus for categorizing an electronic communication containing imagery, the apparatus comprising:
means for applying pre-processing techniques to said imagery in order to locate regions of text in said imagery;
means for measuring one or more characteristics of sets of image pixels within said regions of text; and
means for determining if one or more measured characteristics indicates that said electronic communication is likely to be unsolicited or unauthorized.
